(19) United States
(12) Patent Application Publication
(10) Pub. No.: US 2021/0131523 A1
(43) Pub. Date: May 6, 2021

(54) STEERING DAMPER ASSEMBLY WITH BULGED PORTION

(71) Applicant: DRiV Automotive Inc., Lake Forest, IL (US)

(72) Inventors: Daniel Keil, Temperance, MI (US); Darrell Breese, Saline, MI (US)

(21) Appl. No.: 16/674,608

(22) Filed: Nov. 5, 2019

(51) Int. Cl. F16F 15/027; B62D 6/06; B62D 7/22

(52) U.S. Cl. CPC F16F 15/027; B62D 6/06; F16F 2230/26; F16F 2234/02; B62D 7/228

(57) ABSTRACT

A steering damper assembly includes a cylindrical pressure tube defining a working chamber; a piston assembly disposed in the working chamber; a reserve tube extending circumferentially around the pressure tube and defining a reservoir chamber that is radially between the reserve tube and the pressure tube; a base valve fluidly connecting the working chamber and the reservoir chamber; and a piston rod fixed to the piston assembly. The reserve tube includes a cylindrical portion and a bulged portion. The cylindrical portion extends concentrically around the pressure tube. The bulged portion includes a first circumferential section and a second circumferential section, the first circumferential section having a maximum radial distance at most equal to an inner radius of the cylindrical portion, and the second circumferential section having a maximum radial distance greater than the inner radius of the cylindrical portion.

### BACKGROUND

Vehicles typically include steering systems. During operation of a vehicle, the steering system can be subject to vibrations and shocks from the driving surface. Some steering systems include a steering damper or steering stabilizer to absorb or dampen the vibrations and shocks from the driving surface.

### BRIEF DESCRIPTION OF THE DRAWINGS

FIG. 1 is a perspective view of an example steering damper assembly.

FIG. 2 is a side cross-sectional view of the steering damper assembly with a piston in an extended position.

FIG. 3 is a side cross-sectional view of the steering damper assembly with the piston in a retracted position.

FIG. 4 is a front cross-sectional view of the steering damper.

FIG. 5 is a front cross-sectional view of another example of the steering damper.

### DETAILED DESCRIPTION

With reference to the Figures, a steering damper assembly 30 includes a cylindrical pressure tube 32 including a first endcap 34, a second endcap 36, and a tubular wall 40 defining and extending along an axis A from the first endcap 34 to the second endcap 36, the pressure tube 32 defining a working chamber 42; a piston assembly 44 disposed in the working chamber 42 and dividing the working chamber 42 into a first working chamber 46 adjacent the first endcap 34 and a second working chamber 48 adjacent the second endcap 36; a reserve tube 50 extending circumferentially around the pressure tube 32 and defining a reservoir chamber 52 that is radially between the reserve tube 50 and the pressure tube 32; a base valve 54 fluidly connecting and controlling flow between the second working chamber 48 and the reservoir chamber 52; and a piston rod 56 fixed to the piston assembly 44 and extending through the first endcap 34 of the pressure tube 32. The reserve tube 50 includes a cylindrical portion 58 and a bulged portion 60. The cylindrical portion 58 extends from the first endcap 34 of the pressure tube 32 toward the second endcap 36 of the pressure tube 32 and extends concentrically around the pressure tube 32, the cylindrical portion 58 having an inner radius R_{cyl} from the axis A. The bulged portion 60 includes a first circumferential section 62 and a second circumferential section 64, the first circumferential section 62 having a maximum radial distance L_{bul1} from the axis A at most equal to the inner radius R_{cyl} of the cylindrical portion 58, and the second circumferential section 64 having a maximum radial distance L_{bul2} from the axis A greater than the inner radius R_{cyl} of the cylindrical portion 58.

The steering damper assembly 30 provides a way to mitigate negative effects of air introduced into the reservoir chamber 52. The bulged portion 60 of the reserve tube 50 provides a location for air in the reservoir chamber 52 to go, which can prevent the air from traveling into the working chamber 42. Air in the working chamber 42 can cause lagging in the absorption or dampening of shocks and vibrations. Moreover, the shape of the reserve tube 50 with the cylindrical portion 58 and the bulged portion 60 provides an easy-to-manufacture design using a small number of parts and a small amount of material. Finally, the steering damper assembly 30 has a compact shape, which helps packaging in a steering system of a vehicle.

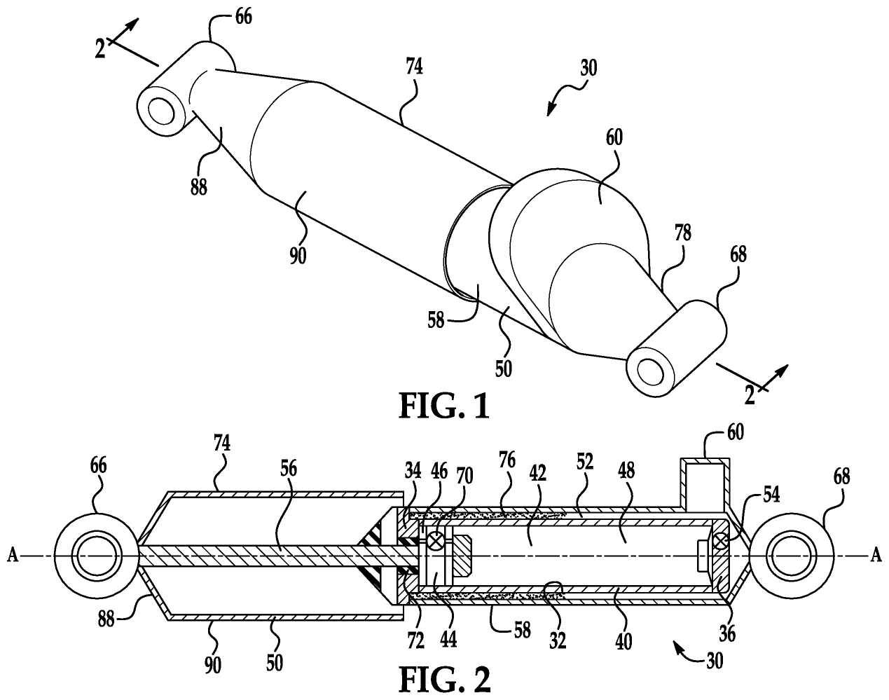

With reference to FIG. 1, the steering damper assembly 30 is mountable to the steering system of the vehicle (not shown). The steering damper assembly 30 includes a first mount 66 and a second mount 68. The mounts 66, 68 are each attachable to a point on the vehicle. For example, one of the mounts 66, 68 can be attached to a point that is fixed relative to a body of the vehicle, and the other of the mounts 66, 68 can be attached to a point that moves with components of the steering system relative to the body of the vehicle. When mounted, the steering damper assembly 30 is oriented generally horizontally, specifically, such that the axis A is oriented generally horizontally. The steering damper assembly 30, also referred to as a steering stabilizer, can absorb vibrations and shocks transmitted through the steering system.

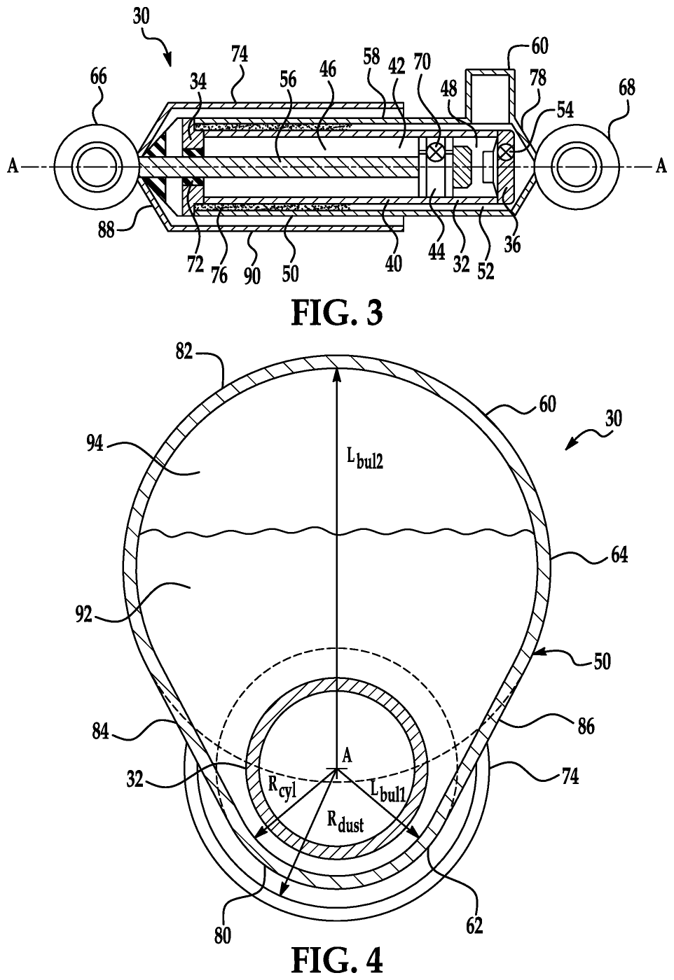

With reference to FIGS. 2 and 3, the pressure tube 32 has a cylindrical shape defining the axis A. The pressure tube 32 includes the first endcap 34, the second endcap 36, and the tubular wall 40. The first endcap 34 and the second endcap 36 each have a circular shape centered on the axis A. The tubular wall 40 has a circular cross-section orthogonal to the axis A, and the circular cross-section is projected from the first endcap 34 to the second endcap 36. The first endcap 34 and the second endcap 36 extend radially inward from the tubular wall 40 toward the axis A. The first endcap 34, the second endcap 36, and the tubular wall 40 are attached to and fixed relative to each other.

The pressure tube 32 defines the working chamber 42. The working chamber 42 is contained within the pressure tube 32. The working chamber 42 is sealed such that fluid can only flow into or out of the working chamber 42 through the base valve 54.

The piston assembly 44 is disposed in the working chamber 42. The piston assembly 44 has a circular cross-section centered on the axis A and forming a seal with the tubular wall 40. The piston assembly 44 contacts and forms a seal with the tubular wall 40 circumferentially for 360° around the axis A. The piston assembly 44 divides the working chamber 42 into the first working chamber 46 and the second working chamber 48. The first working chamber 46 is adjacent the first endcap 34 and is enclosed by the first endcap 34, the tubular wall 40, and the piston assembly 44. The second working chamber 48 is adjacent the second endcap 36 and is enclosed by the second endcap 36, the tubular wall 40, and the piston assembly 44.

The piston assembly 44 includes a piston valve 70. The piston valve 70 permits flow between the first working chamber 46 and the second working chamber 48, i.e., through the piston assembly 44, as the piston assembly 44 moves axially, i.e., translates along the axis A. As the piston assembly 44 and piston rod 56 move axially toward the second endcap 36, the piston valve 70 permits flow of fluid out of the second working chamber 48 into the first working chamber 46 to compensate for the relative change in volume between the first working chamber 46 and the second working chamber 48, and as the piston assembly 44 and piston rod 56 move axially toward the first endcap 34, the base valve 54 permits flow of fluid into the second working chamber 48 from the first working chamber 46 to compensate for the relative change in volume between the first working chamber 46 and the second working chamber 48. The piston valve 70 can be sized to permit a defined rate of flow between the first working chamber 46 and the second working chamber 48.

The piston rod 56 is fixed to the piston assembly 44. The piston rod 56 extends from the piston assembly 44 to and through the first endcap 34 of the pressure tube 32. The piston rod 56 is disposed partially inside the first working chamber 46 and partially outside the pressure tube 32. The piston rod 56 has a constant cross-section that is projected from the piston assembly 44 through the first endcap 34 to the first mount 66. The piston assembly 44, the piston rod 56, and the first mount 66 are attached to and fixed relative to each other.

The first endcap 34 includes a first-endcap seal 72 extending circumferentially around the piston rod 56 and forming a seal with the piston rod 56. The first-endcap seal 72 prevents fluid in the first working chamber 46 from leaking out of the pressure tube 32 along the piston rod 56.

The base valve 54 fluidly connects and controls flow between the second working chamber 48 and the reservoir chamber 52. The base valve 54 extends through the second endcap 36. As the piston assembly 44 and piston rod 56 move axially toward the second endcap 36, the base valve 54 permits flow of fluid out of the second working chamber 48 into the reservoir chamber 52 to compensate for the additional volume in the working chamber 42 occupied by the piston rod 56, and as the piston assembly 44 and piston rod 56 move axially toward the first endcap 34, the base valve 54 permits flow of fluid into the second working chamber 48 from the reservoir chamber 52 to compensate for the reduction in volume in the working chamber 42 occupied by the piston rod 56. The base valve 54 can be sized to permit a defined rate of flow between the second working chamber 48 and the reservoir chamber 52.

The first mount 66 provides a location to attach the steering damper assembly 30 to a steering system. The first mount 66 can permit rotation in one or more dimensions of the steering damper assembly 30 relative to the component of the steering system to which the first mount 66 is attached. For example, the first mount 66 can be a pin joint, ball joint, etc.

The first mount 66, the piston rod 56, the piston assembly 44, and a dust shield 74 (described below) together form a rigid body, i.e., are connected to each other and fixed relative to each other. The first mount 66, the piston rod 56, the piston assembly 44, and the dust shield 74 are axially movable together relative to the pressure tube 32 between a retracted position with the piston assembly 44 at a closest position to the second endcap 36, as shown in FIG. 3, and an extended position with the piston assembly 44 at a farthest position from the second endcap 36, as shown in FIG. 2. As the rigid body axially moves from the extended position to the retracted position, fluid moves from the second working chamber 48 to the first working chamber 46 through the piston valve 70, and fluid moves from the second working chamber 48 to the reservoir chamber 52 through the base valve 54. As the rigid body axially moves from the retracted position to the extended position, fluid moves from the first working chamber 46 to the second working chamber 48 through the piston valve 70, and fluid moves from the reservoir chamber 52 to the second working chamber 48 through the base valve 54.

The reserve tube 50 extends circumferentially around the pressure tube 32 and extends axially from the first endcap 34 past the second endcap 36 to the second mount 68. The reserve tube 50 includes the cylindrical portion 58, the bulged portion 60, and a conical portion 78. The reserve tube 50 is an integral piece, i.e., made of a single, uniform piece of material with no seams, joints, fasteners, or adhesives holding it together.

The reserve tube 50 defines the reservoir chamber 52. The reservoir chamber 52 is radially between the reserve tube 50 and the pressure tube 32, i.e., radially inside the reserve tube 50 and radially outside the pressure tube 32. The reservoir chamber 52 extends from the first endcap 34 to the conical portion 78. The first endcap 34 extends radially outward from the pressure tube 32 to the reserve tube 50. The reservoir chamber 52 extends between the second endcap 36 and the second mount 68. The reservoir chamber 52 is sealed except for the base valve 54. The reservoir chamber 52 and the working chamber 42 are together completely sealed from an environment outside the reserve tube 50, i.e., there are no fluid paths between the working chamber 42 or reservoir chamber 52 and the environment outside the reserve tube 50.

The cylindrical portion 58 extends axially from the first endcap 34 toward the second endcap 36 and extends to the bulged portion 60. The cylindrical portion 58 extends concentrically around the pressure tube 32. The cylindrical portion 58 has a cylindrical shape defining the axis A. The cylindrical portion 58 has a circular cross-section orthogonal to the axis A, and the circular cross-section is projected from the first endcap 34 to the bulged portion 60 along the axis A. The cylindrical portion 58 has an inner radius R_{cyl} measured from the axis A to an inner surface of the cylindrical portion 58, i.e., to a surface facing inward to the reservoir chamber 52.

The steering damper assembly 30 includes a foam member 76 disposed in the reservoir chamber 52. The foam member 76 extends circumferentially around the pressure tube 32, extends radially outward from the pressure tube 32 to the reserve tube 50, specifically to the cylindrical portion 58 of the reserve tube 50, and extends axially from the first endcap 34 toward the second endcap 36. The foam member 76 is axially spaced from the bulged portion 60. The foam member 76 can be a rubber, e.g., neoprene.

The bulged portion 60 extends axially from the cylindrical portion 58 to the conical portion 78 of the reserve tube 50. The bulged portion 60 extends circumferentially relative to the axis A completely around the second endcap 36, and the bulged portion 60 is spaced from the second endcap 36. The bulged portion 60 includes the first circumferential section 62 and the second circumferential section 64. The circumferential sections extend axially from the cylindrical portion 58 to the conical portion 78. The first circumferential section 62 extends circumferentially partially around the axis A from the second circumferential section 64 to the second circumferential section 64, and the second circumferential section 64 extends circumferentially partially around the axis A from the first circumferential section 62 to the first circumferential section 62. When the steering damper assembly 30 is mounted to the steering system, the first circumferential section 62 faces downward, and the second circumferential section 64 faces upward; in other words, the first circumferential section 62 is disposed below the pressure tube 32, and the second circumferential section 64 is disposed above the pressure tube 32.

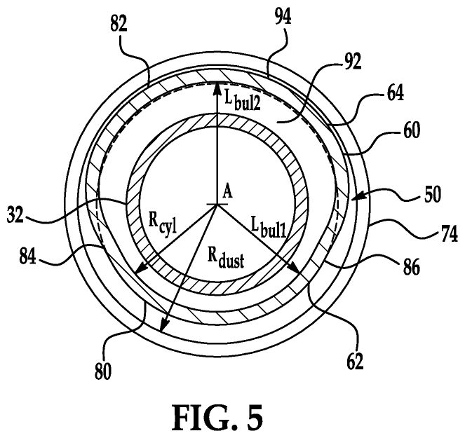

With reference to FIGS. 4 and 5, the bulged portion 60 has a constant cross-sectional shape projected along the axis A from the cylindrical portion 58 to the conical portion 78. The cross-sectional shape includes a first arc of circle 80 at least partially defining the first circumferential section 62, a second arc of circle 82 at least partially defining the second circumferential section 64, a first straight line 84 extending from the first arc of circle 80 to the second arc of circle 82, and a second straight line 86 extending from the first arc of circle 80 to the second arc of circle 82. The straight lines 84, 86 connect tangentially to the arcs of circle 80, 82. The cross-sectional shape can have a constant wall thickness following the first arc of circle 80, the second arc of circle 82, the first straight line 84, and the second straight line 86, as shown in FIGS. 4 and 5. Alternatively, the cross-sectional shape can have a nonuniform wall thickness following the first arc of circle 80, the second arc of circle 82, the first straight line 84, and the second straight line 86. The first arc of circle 80 can define the first circumferential section 62, and the second arc of circle 82 and the straight lines 84, 86 can define the second circumferential section 64. The first circumferential section 62 has a maximum radial distance L_{bul1} from the axis A at most equal to the inner radius R_{cyl} of the cylindrical portion 58, e.g., as shown in FIG. 4, equal to the inner radius R_{cyl}. The second circumferential section 64 has a maximum radial distance L_{bul2} from the axis A greater than the inner radius R_{cyl} of the cylindrical portion 58, e.g., greater than twice the inner radius R_{cyl}.

Returning to FIGS. 2 and 3, the second mount 68 provides a location to attach the steering damper assembly 30 to the steering system. The second mount 68 can permit rotation in one or more dimensions of the steering damper assembly 30 relative to the component of the steering system to which the second mount 68 is attached. For example, the second mount 68 can be a pin joint, ball joint, etc. The second mount 68, the reserve tube 50, and the pressure tube 32 together form a rigid body. The first mount 66, the piston rod 56, the piston assembly 44, and the dust shield 74 move axially together relative to the second mount 68, the reserve tube 50, and the pressure tube 32.

The dust shield 74 is fixed relative to the piston rod 56 and extends from the piston rod 56. The dust shield 74 includes a conical portion 88 and a cylindrical portion 90. The conical portion 88 extends radially outward from the piston rod 56 at the first mount 66, and the conical portion 88 extends axially from the first mount 66 toward the second mount 68. The cylindrical portion 90 extends from the conical portion 88 away from the first mount 66 toward the second mount 68. The cylindrical portion 90 of the dust shield 74 extends circumferentially around the cylindrical portion 58 of the reserve tube 50. The cylindrical portion 90 of the dust shield 74 has a cylindrical shape positioned concentrically around the cylindrical portion 58 of the reserve tube 50, i.e., centered around the axis A. The end of the cylindrical portion 90 of the dust shield 74 axially closest to the second mount 68 is not directly attached to any other components of the steering damper assembly 30. An inner radius R_{dust} of the cylindrical portion 90 of the dust shield 74 can be smaller than the maximum radial distance L_{bul2} from the axis A to the second circumferential section 64 of the bulged portion 60 of the reserve tube 50, as shown in FIG. 4. The bulged portion 60 can extend outside of the inner radius R_{dust} of the dust shield 74, as shown in FIG. 4, or the bulged portion 60 can extend no farther than the inner radius R_{dust} of the dust shield 74, as shown in FIG. 5.

The dust shield 74 is axially movable relative to the pressure tube 32 between the retracted position and the extended position, along with the first mount 66, the piston rod 56, and the piston assembly 44. The dust shield 74 in the extended position, as shown in FIG. 2, exposes a portion, e.g., more than half of an axial length, of the cylindrical portion 58 of the reserve tube 50, and the dust shield 74 in the extended position exposes the bulged portion 60 of the reserve tube 50. The dust shield 74 in the retracted position, as shown in FIG. 3, mostly or entirely covers, e.g., covers more than half of an axial length of, the cylindrical portion 58 of the reserve tube 50. In one example, with the cross-sectional shape of the bulged portion 60 shown in FIG. 4, the dust shield 74 in the retracted position exposes the bulged portion 60 of the reserve tube 50. In other words, the dust shield 74 exposes the bulged portion 60 of the reserve tube 50 regardless of the position of the dust shield 74. In another example, with the cross-sectional shape of the bulged portion 60 shown in FIG. 5, the dust shield 74 in the retracted position can cover the cylindrical portion 58 of the reserve tube 50 and can at least partially cover the bulged portion 60 of the reserve tube 50.

With reference to FIGS. 2-5, the steering damper assembly 30 includes oil 92 as a working fluid. The oil 92 fills the working chamber 42 and fills a majority of the reservoir chamber 52. When the steering damper assembly 30 is oriented so that the axis A is oriented horizontally and the second circumferential section 64 faces upward, e.g., when the steering damper assembly 30 is installed in the steering system, the oil 92 fills the reservoir chamber 52 between the pressure tube 32 and the cylindrical portion 58 of the reserve tube 50, and the oil 92 incompletely fills the reservoir chamber 52 between the pressure tube 32 and the bulged portion 60 of the reserve tube 50; in particular, the oil 92 fills the reservoir chamber 52 between the first circumferential section 62 and extends above the pressure tube 32 in the second circumferential section 64 but leaves an air pocket 94 at a top of the second circumferential section 64. If air is introduced to the reservoir chamber 52, the air will travel through the oil 92, which is denser, to the air pocket 94, which is at a highest location of the reservoir chamber 52, rather than possibly traveling into the working chamber 42.

The disclosure has been described in an illustrative manner, and it is to be understood that the terminology which has been used is intended to be in the nature of words of description rather than of limitation. The adjectives “first” and “second” are used throughout this document as identifiers and are not intended to signify importance, order, or quantity. Many modifications and variations of the present disclosure are possible in light of the above teachings, and the disclosure may be practiced otherwise than as specifically described.

What is claimed is:

1. A steering damper assembly comprising:
a cylindrical pressure tube including a first endcap, a second endcap, and a tubular wall defining and extending along an axis from the first endcap to the second endcap, the pressure tube defining a working chamber;
a piston assembly disposed in the working chamber and dividing the working chamber into a first working chamber adjacent the first endcap and a second working chamber adjacent the second endcap;
a reserve tube extending circumferentially around the pressure tube and defining a reservoir chamber that is radially between the reserve tube and the pressure tube;
a base valve fluidly connecting and controlling flow between the second working chamber and the reservoir chamber; and
a piston rod fixed to the piston assembly and extending through the first endcap of the pressure tube;
wherein the reserve tube includes a cylindrical portion and a bulged portion;
the cylindrical portion extends from the first endcap of the pressure tube toward the second endcap of the pressure tube and extends concentrically around the pressure tube, the cylindrical portion having an inner radius from the axis; and
the bulged portion includes a first circumferential section and a second circumferential section, the first circumferential section having a maximum radial distance from the axis at most equal to the inner radius of the cylindrical portion, and the second circumferential section having a maximum radial distance from the axis greater than the inner radius of the cylindrical portion.

2. The steering damper assembly of claim 1, further comprising a dust shield fixed relative to the piston rod and extending circumferentially around the cylindrical portion of the reserve tube.

3. The steering damper assembly of claim 2, wherein
the dust shield is axially movable relative to the pressure tube with the piston rod between a retracted position and an extended position;
the dust shield in the extended position exposes a portion of the cylindrical portion of the reserve tube and exposes the bulged portion of the reserve tube.

4. The steering damper assembly of claim 3, wherein the dust shield in the retracted position exposes the bulged portion of the reserve tube.

5. The steering damper assembly of claim 3, wherein the dust shield in the retracted position entirely covers the cylindrical portion of the reserve tube and at least partially covers the bulged portion of the reserve tube.

6. The steering damper assembly of claim 2, wherein the dust shield has a cylindrical shape positioned concentrically around the cylindrical portion of the reserve tube.

7. The steering damper assembly of claim 1, wherein the bulged portion has a constant cross-sectional shape projected along the axis.

8. The steering damper assembly of claim 7, wherein the cross-sectional shape includes a first arc of circle at least partially defining the first circumferential section and a second arc of circle at least partially defining the second circumferential section.

9. The steering damper assembly of claim 8, wherein the cross-sectional shape includes a first straight line extending from the first arc of circle to the second arc of circle and a second straight line extending from the first arc of circle to the second arc of circle.

10. The steering damper assembly of claim 9, wherein the straight lines connect tangentially to the arcs of circle.

11. The steering damper assembly of claim 1, wherein the bulged portion extends circumferentially around the second endcap.

12. The steering damper assembly of claim 1, wherein the base valve extends through the second endcap.

13. The steering damper assembly of claim 1, wherein the reserve tube is an integral piece.

14. The steering damper assembly of claim 1, wherein the working chamber and the reservoir chamber are completely sealed from an environment outside the reserve tube.

15. The steering damper assembly of claim 1, wherein the piston assembly includes a piston valve permitting flow between the first working chamber and the second working chamber as the piston assembly moves axially.

16. The steering damper assembly of claim 1, further comprising a foam member disposed in the reservoir chamber.

17. The steering damper assembly of claim 16, wherein the foam member extends circumferentially around the pressure tube and radially outward from the pressure tube to the reserve tube.

18. The steering damper assembly of claim 16, wherein the foam member extends axially from the first endcap toward the second endcap.

19. The steering damper assembly of claim 1, further comprising oil filling the working chamber.

20. The steering damper assembly of claim 19, wherein when the axis is oriented horizontally and the second circumferential section of the bulged portion of the reserve tube faces upward, the oil fills the reservoir chamber between the pressure tube and the cylindrical portion of the reserve tube, and the oil incompletely fills the reservoir chamber between the pressure tube and the bulged portion of the reserve tube.
